(19) United States
(12) Patent Application Publication
(10) Pub. No.: US 2007/0019825 A1
(43) Pub. Date: Jan. 25, 2007

(54) In-vehicle audio processing apparatus

(76) Inventors: Toru Marumoto, Iwaki-city (JP); Shingo Kiuchi, Yachiyo-city (JP); Nozomu Saito, Iwaki-city (JP)

Correspondence Address: BRINKS HOFER GILSON & LIONE, P.O. BOX 10395, CHICAGO, IL, 60610, US

(21) Appl. No.: 11/477,725

(22) Filed: Jun. 28, 2006

(30) Foreign Application Priority Data
Jul. 5, 2005 (JP) 2005-196128

(51) Int. Cl. H04B 15/00

(52) U.S. Cl. 381/94.1

(57) ABSTRACT

On the basis of status information on a vehicle collected by a status information input interface from a navigation device, an ECU, and sensors, an S/N ratio estimating unit estimates, as an S/N ratio, the level of the ratio between the power of a component corresponding to audio-device output sound y(j) and that corresponding to noise sound n(j) contained in a microphone output signal. A transfer-function variation estimating unit estimates the level of a variation in a transfer function of an audio-device output audio signal transfer system. An adaptive characteristics controller controls a characteristic of a coefficient updating operation of a tap coefficient of an FIR filter performed by a coefficient updating unit of an adaptive filter, i.e., an adaptation (learning) characteristic of the adaptive filter, in response to the S/N ratio level and the level of the variation in the transfer function.

### BACKGROUND

1. Field of the Disclosure

The present disclosure relates to an audio processing apparatus that uses an adaptive filter to estimate an output sound that is output from an audio output device and then input to a microphone.

2. Description of the Related Art

Techniques are known for using a microphone to detect a guiding voice output from a speaker of a navigation device and ambient noise, and to adjust a gain of the guiding voice output from the navigation device based on both a power of the noise component contained in an audio signal output from the microphone and a power of the guiding voice component contained in the signal output form the microphone. Both the power of the noise component and the power of the guiding voice component are estimated on the basis of the guiding voice output from the navigation apparatus (see, for example, Japanese Unexamined Patent Application Publication No. 11-166835).

In one technique, an adaptive filter learns a transfer function of a system having an input and an output. The input of the system is an audio signal that is output from the navigation device to the speaker for outputting voice. The output of the system is an audio signal that is output from the microphone. By using the adaptive filter and the audio signal output from the audio output device to the speaker, a system can estimate a voice component that has been output from the speaker contained in the audio signal output from the microphone. The audio signal output from the microphone minus the estimated voice component is estimated as a noise component contained in the audio signal output from the microphone.

One technique that includes an adaptive filter includes an FIR filter and a coefficient updating unit for updating a tap coefficient of the FIR filter. The coefficient updating unit updates the tap coefficient of the FIR filter by employing a Least Mean Square (LMS) algorithm, a normalized LMS (NLMS) algorithm, or another algorithm. Updating the tap coefficient of the FIR filter corresponds to learning a transfer function, and an adaptive algorithm is an algorithm such as the LMS and NLMS algorithms used to update the tap coefficient.

With respect to adaptive algorithms, a block-processing NLMS algorithm is known that is adapted in an echo canceller of a voice communication device and represented by the following expression:

$$w ( n + 1 ) = w ( n ) + μ \cdot \frac{1}{{\sum }_{j = nL + 1}^{( n + 1 ) L} {x ( j )}^{T} ⨯ ( j )} \cdot {\sum }_{j = nL + 1}^{( n + 1 ) L} e ( j ) ⨯ ( j )$$

where w(n) is the tap coefficient of a FIR filter whose input is a received audio signal, x(j) is the received audio signal, e(j) is an error between an output audio signal of a transmission microphone and an output of the FIR filter, m is a step size parameter, and L is a block length (see, for example, Kensaku FUJII and Juro OHGA, “Onkyou ekou kyansera notameno suiteigosa wo shoyouchi ni tamotsu houhou,” IEICE Transactions A (Japanese Edition), Vol. J83A, No. 2, February 2000, pages 141-151).

This adaptive filter learns a transfer function from the speaker output of the received audio signal to the output of the transmission microphone, i.e., a transfer function of an echo path of the received audio signal. In this technique, the level of a disturbance sound (sound other than the received audio component, i.e., noise) and the change in the transfer function of the echo path are estimated on the basis of the error e(j) between the output audio signal of the transmission microphone and the output of the FIR filter. In responses to the estimations, the step size parameter m and the block length L are adjusted. In this technique, the change in the transfer function and the change in the disturbance sound component are identified by correlation calculation of the output of the FIR filter and the error e(j) between the output of the transmission microphone and the output of the FIR filter.

As described in the IEICE paper mentioned above, it is expected that, when the transfer function of the echo path widely varies, increasing the step size parameter m enables adaptation (learning) to quickly converge. Additionally, it is expected that, when the received audio signal component is smaller than the disturbance sound component in the audio signal that is output from the transmission microphone, increasing the block length L improves the accuracy of adaptation (learning).

When an audio processing apparatus that uses an adaptive filter to estimate an output sound that is output from an audio output device and then input to a microphone is employed as an in-vehicle system, the level of ambient noise and the transfer function in the vehicle are prone to widely vary at relatively frequent intervals. With a conventional in-vehicle audio processing apparatus which estimates the output sound of the audio output device by using an adaptive filter employing the LMS or NLMS algorithms, when the noise level is large or the transfer function widely varies, the output sound of the audio output device cannot be estimated with a high degree of accuracy using the adaptive filter.

In the technique employing the adaptive filter used for echo canceling described in the IEICE paper mentioned above, the change in the transfer function and the change in the disturbance sound component are identified by performing a correlation calculation of the output of the FIR filter and the error between the output of the transmission microphone and the output of the FIR filter. However, performing correlation calculations results in an increased in the amount of calculations.

### BRIEF SUMMARY

It is an object of the present disclosure to, in an audio processing apparatus that uses an adaptive filter to estimate an output sound that is output from an audio output device and then input to a microphone, allow the adaptive filter to carry out an adaptive (learning) operation with increased accuracy without a large increase in the amount of calculations that are performed even when the noise level is large or the transfer function widely varies.

According to a first aspect of the present disclosure, an in-vehicle audio processing apparatus mounted in a vehicle includes an audio output device, a speaker for outputting an output audio signal output from the audio output device as an output sound, a microphone for outputting a picked up sound as an input audio signal, an adaptive filter for performing an adaptation operation of causing a first transfer function of the adaptive filter to approximate a second transfer function of a system whose input is the output audio signal and whose output is the input audio signal and for applying the first transfer function of the adaptive filter to the output audio signal and outputting a simulation audio signal which simulates a component corresponding to the output sound contained in the input audio signal, a vehicle-status collecting unit for collecting a vehicle status regarding surroundings of the in-vehicle audio processing apparatus, and an adaptive characteristic controller for controlling a control parameter of the adaptation operation of the adaptive filter in response to the vehicle status collected by the vehicle-status collecting unit.

According to such an in-vehicle audio processing apparatus, the vehicle status regarding surroundings of the in-vehicle audio processing apparatus can be collected, the surroundings of the in-vehicle audio processing apparatus can be estimated from the collected vehicle status, and a control parameter (e.g., the step size parameter or block length in the block-processing NLMS algorithm described above) of the adaptation operation of the adaptive filter can be switched in response to the estimated surroundings and their changes. As a result, a control parameter of an adaptation operation of appropriately selecting the vehicle status to be collected, estimating the noise level input to the microphone as the surroundings, and allowing the adaptation operation to match the estimated noise level can be set in the adaptive filter. Alternatively, a control parameter of an adaptation operation of appropriately selecting the vehicle status to be collected and the surroundings to be estimated, estimating a change in the transfer function from a change in the estimated surroundings, and allowing the adaptation operation to match the estimated change in the transfer function can be set in the adaptive filter. Therefore, even when the noise level is large or the transfer function widely varies, the adaptive filter can perform the adaptation (learning) operation with increased accuracy. Additionally, since complicated calculations, such as correlation calculations, are not required, there is not a large increase in the amount of calculations performed.

More specifically, in the in-vehicle audio processing apparatus, the vehicle-status collecting unit may collect a vehicle status that influences a change in the second transfer function of the system whose input is the output audio signal and whose output is the input audio signal. In this case, furthermore, the adaptive filter may include an FIR filter and a coefficient updating unit for updating a tap coefficient of the FIR filter, and the adaptive characteristic controller may change a step size parameter defining a gain of correction of the tap coefficient, the correction being performed in updating the tap coefficient of the FIR filter by the coefficient updating unit, in response to a change in the vehicle status collected by the vehicle-status collecting unit.

As the vehicle status that influences the change in the second transfer function, at least one of an operation status of driving equipment of the vehicle, an operation status of subsidiary equipment of the vehicle, an operation status of accessory equipment of the vehicle, an open/close status of a window of the vehicle, an open/close status of a door of the vehicle, a status of a position at which a person rides in the vehicle, a status of a position at which a seat of the vehicle is set, and a status of a temperature inside the vehicle may be used.

Therefore, a control parameter of an adaptation operation of estimating a change in the transfer function of the in-vehicle audio processing apparatus from the collected vehicle status and allowing the adaptation operation to match the change in the transfer function can be set in the adaptive filter. As a result, even when the transfer function widely varies, the adaptive filter can perform the adaptation (learning) operation with increased accuracy.

Alternatively, in the in-vehicle audio processing apparatus, the vehicle-status collecting unit may collect a vehicle status that influences a magnitude of noise inside the vehicle. In this case, the adaptive filter may include an FIR filter and a coefficient updating unit for updating a tap coefficient of the FIR filter on the basis of an adaptive algorithm including block processing in which an amount of correction of the tap coefficient is calculated using data for a length of time set as a block length to update the tap coefficient, and wherein the adaptive characteristic controller may change the block length of the block processing performed by the coefficient updating unit, in response to a change in the vehicle status collected by the vehicle-status collecting unit.

As the vehicle status that influences the magnitude of noise inside the vehicle, at least one of a status of a vehicle speed, a status of a type of a road where the vehicle is traveling, a status of weather of an area in which the vehicle is traveling, and a status of congestion at a point where the vehicle is traveling may be used.

For example, the vehicle-status collecting unit may collect at least a status of a vehicle speed as the vehicle status that influences the magnitude of noise inside the vehicle, and the adaptive characteristic controller may set the block length of the block processing performed by the coefficient updating unit at a value determined depending on the vehicle speed collected by the vehicle-status collecting unit. Alternatively, for example, the vehicle-status collecting unit may collect, as the vehicle status that influences the magnitude of noise inside the vehicle, at least one of a status of a vehicle speed, a status of a type of a road where the vehicle is traveling, a status of weather of an area in which the vehicle is traveling, and a status of congestion at a point where the vehicle is traveling, and the adaptive characteristic controller may set the block length of the block processing performed by the coefficient updating unit at a value determined depending on a combination of one or more statuses collected by the vehicle-status collecting unit.

Therefore, a control parameter of an adaptation operation of estimating the magnitude of noise inside the vehicle from the collected vehicle status and allowing the adaptation operation to match the estimated magnitude of noise can be set in the adaptive filter. As a result, even when the magnitude of noise is large, the adaptive filter can perform the adaptation (learning) operation with increased accuracy.

Alternatively, in the in-vehicle audio processing apparatus, the vehicle-status collecting unit may collect a vehicle status that influences a change in the second transfer function of the system whose input is the output audio signal and whose output is the input audio signal and a vehicle status that influences a magnitude of noise inside the vehicle. In this case, the adaptive filter may include an FIR filter and a coefficient updating unit for updating a tap coefficient of the FIR filter on the basis of an adaptive algorithm including block processing in which an amount of correction of the tap coefficient is calculated using data for a length of time set as a block length to update the tap coefficient, and the adaptive characteristic controller may change a step size parameter defining a gain of correction of the tap coefficient, the correction being performed in updating the tap coefficient of the FIR filter by the coefficient updating unit, in response to a change in the vehicle status that influences the change in the second transfer function of the system whose input is the output audio signal and whose output is the input audio signal and may change the block length of the block processing performed by the coefficient updating unit, in response to a change in the vehicle status that influences the magnitude of noise inside the vehicle collected by the vehicle-status collecting unit.

More specifically, for example, the coefficient updating unit in the adaptive filter may update the tap coefficient of the FIR filter using the following expression:

$$w ( n + 1 ) = w ( n ) + μ \cdot \frac{1}{{\sum }_{j = nL + 1}^{( n + 1 ) L} ⨯ {( j )}^{T} ⨯ ( j )} \cdot {\sum }_{j = nL + 1}^{( n + 1 ) L} e ( j ) ⨯ ( j )$$

where w(n) is the tap coefficient of the FIR filter, x(j) is the output audio signal output from the audio output device, e(j) is a difference between the input audio signal and the simulation audio signal, m is the step size parameter, and L is the block length, and the adaptive characteristic controller may change the step size parameter m in response to the change in the vehicle status that influences the change in the second transfer function of the system whose input is the output audio signal and whose output is the input audio signal collected by the vehicle-status collecting unit and may change the block length L in response to the change in the vehicle status that influences the magnitude of noise inside the vehicle collected by the vehicle-status collecting unit.

Therefore, a control parameter of an adaptation operation of estimating the noise level and/or the transfer-function change from the collected vehicle status and allowing the adaptation operation to match the estimated noise level and/or the estimated transfer-function change can be set in the adaptive filter. As a result, even when the noise level is large or the transfer function widely varies, the adaptive filter can perform the adaptation (learning) operation with increased accuracy.

The in-vehicle audio processing apparatus may further include a voice recognition device for applying voice recognition processing to an audio signal obtained by subtracting the simulation audio signal from the input audio signal.

As described above, according to the present disclosure, in an audio processing apparatus that estimates an output sound that is output from an audio output apparatus and then input to a microphone by using an adaptive filter, the adaptive filter can perform an adaptive operation (learning) with increased accuracy without a large increase in the amount of calculation even when the noise level is large or the transfer function widely varies.

### BRIEF DESCRIPTION OF THE DRAWINGS

FIG. 1 is a block diagram of one embodiment of an in-vehicle audio processing apparatus;

FIG. 2 is a block diagram of one embodiment of a signal-to-noise (S/N) ratio estimating unit;

FIG. 3 is a block diagram illustrating an example configuration of one embodiment of a transfer-function variation estimating unit;

FIG. 4 is a block diagram illustrating an example configuration of another embodiment of a transfer-function variation estimating unit;

FIG. 5 is a flowchart that illustrates one embodiment of transfer-function change level determination processing;

FIG. 6 is a flowchart that illustrates one embodiment of adaptive characteristic control processing; and

FIG. 7 illustrates a table used in one embodiment of the adaptive characteristic control processing.

### DETAILED DESCRIPTION OF THE DRAWINGS

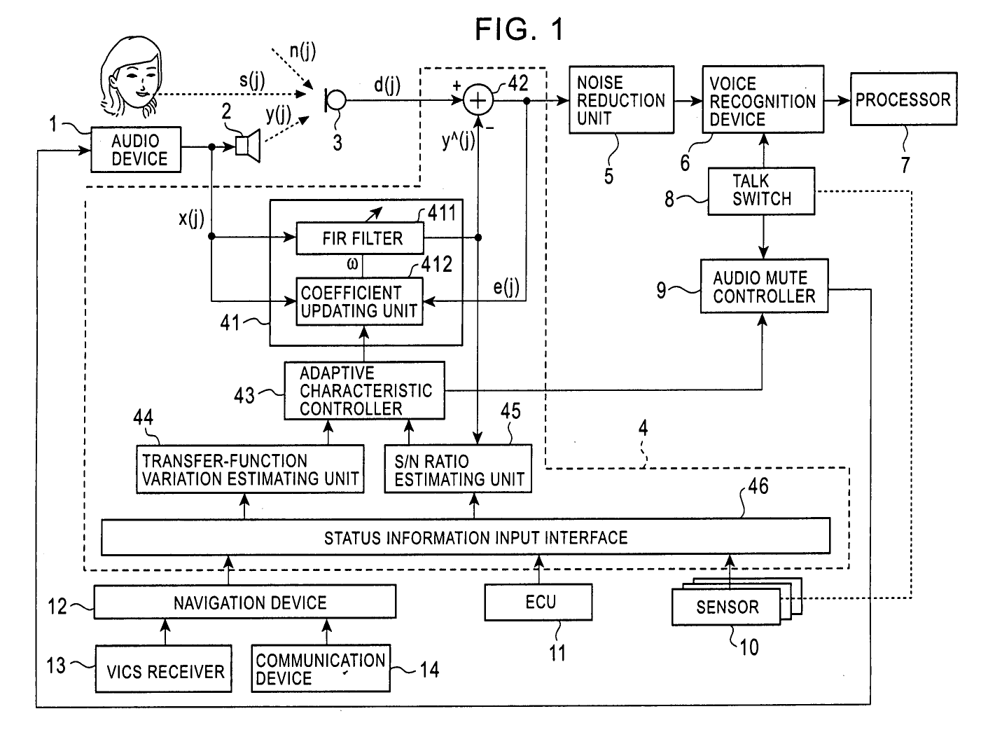

FIG. 1 illustrates a structure of one embodiment of an in-vehicle audio processing apparatus. As illustrated in FIG. 1, the in-vehicle audio processing apparatus includes an audio device 1 (e.g., a radio receiver or CD player), a speaker 2 for outputting a sound from the audio device 1, a microphone 3, an audio-device output sound removing unit 4, a noise reduction unit 5, a voice recognition unit 6, a processor 7, a talk switch 8, an audio mute controller 9, a plurality of sensors 10 for detecting various vehicle statuses, an electronic control unit (ECU) 11 for controlling each part, including an engine and a transmission of the vehicle, and detecting vehicle speed, hydraulic pressure, and other vehicle statues, a navigation device 12, a Vehicle Information and Communication System (VICS) receiver 13 for receiving traffic information broadcasting, and a communication device 14 for connecting to a mobile telephony network.

The audio-device output sound removing unit 4 includes an adaptive filter 41, an adder 42, an adaptive characteristic controller 43, a transfer-function variation estimating unit 44, an S/N ratio estimating unit 45, and a status information input interface 46. The adaptive filter 41 includes an FIR filter 411 and a coefficient updating unit 412 for using a predetermined adaptive algorithm to update a tap coefficient w of the FIR filter 411.

In the structure described above, an audio-device output audio signal x(j) that has been output from the audio device 1 is output from the speaker 2. An audio-device output sound y(j) that has been output from the speaker 2, a user's uttered speech s(j), and other noise sound n(j) are detected by the microphone 3 and output as an audio signal d(j). For the sake of convenience, this signal output from the microphone is referred to as “microphone output signal.”

The microphone output signal d(j) is input to the audio-device output sound removing unit 4. The audio-device output sound removing unit 4 refers to the audio-device output audio signal x(j) output from the audio device 1, removes a component corresponding to the audio-device output sound y(j) from the microphone output audio signal d(j), and outputs as an audio signal e(j) to the noise reduction unit 5. The noise reduction unit 5 removes a component corresponding to the other noise sound n(j) from the audio signal e(j) input from the audio-device output sound removing unit 4 and then outputs to the voice recognition unit 6. The voice recognition unit 6 performs voice recognition on the audio signal input from the noise reduction unit 5 to recognize the content of the user's utterance and inputs the recognition result into the processor 7. The processor 7 performs processing depending on the recognition result input from the voice recognition unit 6.

The talk switch 8 serves as a switch that is switched to the ON state when a user starts voice input. Typically, the voice recognition unit 6 performs the voice recognition described above while the talk switch 8 is in the ON state.

In the audio-device output sound removing unit 4, the FIR filter 411 of the adaptive filter 41 is a filter that simulates a transfer function of a transfer system whose input is the audio-device output audio signal x(j) output from the audio device 1 and whose output is the output from the microphone 3 (hereinafter, this system is referred to as “audio-device output audio signal transfer system”). The FIR filter 411 creates a simulation audio signal yˆ(j) which simulates the audio-device output sound y(j) component contained in the microphone output audio signal d(j) by applying the simulated transfer function on the input audio-device output audio signal x(j) and then outputs the created signal.

In the audio-device output sound removing unit 4, the adder 42 removes the audio-device output sound y(j) component from the microphone output audio signal d(j) by subtracting the simulation audio signal yˆ(j) output from the FIR filter 411, thereby creating the audio signal e(j).

In the audio-device output sound removing unit 4, the coefficient updating unit 412 of the adaptive filter 41 sets or updates a tap coefficient of the FIR filter 411 on the basis of the audio signal e(j) output from the adder 42 and the audio-device output audio signal x(j) so that an impulse response of the FIR filter 411 is equal to that of the audio-device output audio signal transfer system, on the basis of a predetermined adaptive algorithm.

In the audio-device output sound removing unit 4, the S/N ratio estimating unit 45 estimates the level of the ratio between the audio-device output sound y(j) component and the other noise sound n(j) component contained in the microphone output audio signal d(j) as the level of the S/N ratio. The transfer-function variation estimating unit 44 estimates the level of the variation in the transfer function of the audio-device output audio signal transfer system. The adaptive characteristic controller 43 controls a characteristic of an updating operation of the tap coefficient of the FIR filter 411 performed by the coefficient updating unit 412, i.e., a characteristic of an adaptation (learning) operation of the adaptive filter 41 by controlling a variable used in the adaptive algorithm implemented by the coefficient updating unit 412 in the adaptive filter 41 in response to the level of the S/N ratio estimated by the S/N ratio estimating unit 45 and the transfer function variation level estimated by the transfer-function variation estimating unit 44.

In the audio-device output sound removing unit 4, the status information input interface 46 collects, from the navigation device 12, the ECU 11, and the sensors 10, vehicle status information to be used when the S/N ratio estimating unit 45 estimates the level of the S/N ratio in and the transfer-function variation estimating unit 44 estimates the transfer function variation level and supplies the collected information to the S/N ratio estimating unit 45 and the transfer-function variation estimating unit 44.

Then, in the case where a recognition audio mute mode is set by the adaptive characteristic controller 43 in the audio-device output sound removing unit 4, the audio mute controller 9 controls the audio device 1 to stop outputting the audio-device output audio signal x(j) while the talk switch 8 is in the ON state.

The details of the S/N ratio estimating unit 45, the transfer-function variation estimating unit 44, and the adaptive characteristic controller 43 in the audio-device output sound removing unit 4 are described below.

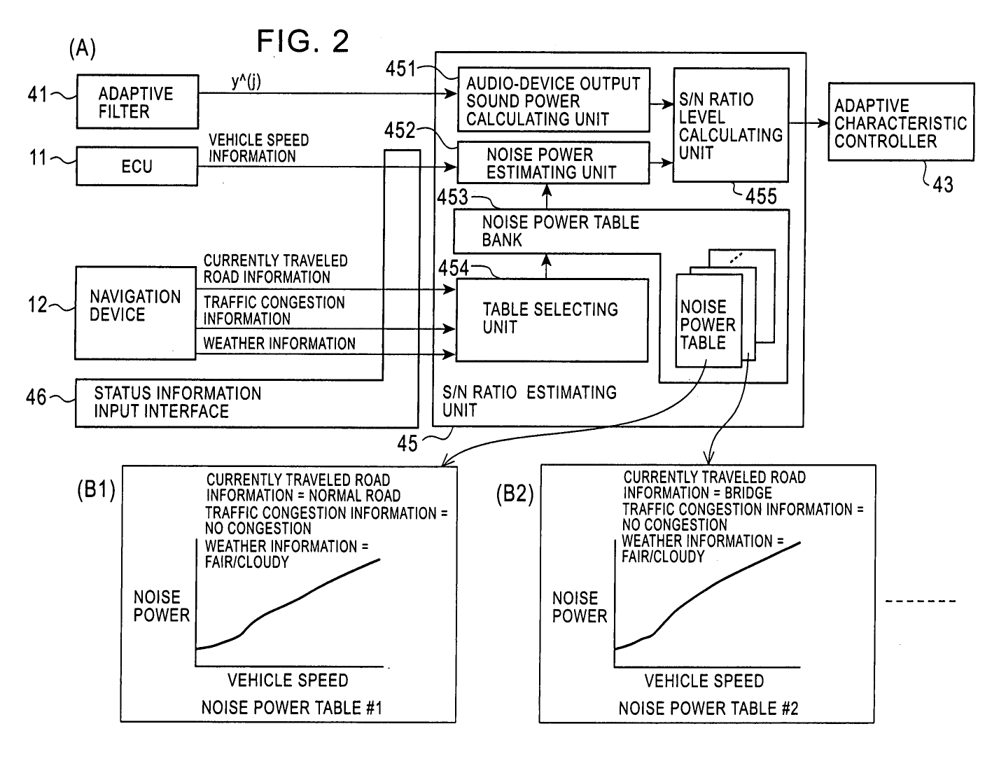

FIG. 2 illustrates one embodiment of a structure of the S/N ratio estimating unit 45 in part A. As illustrated, the S/N ratio estimating unit 45 includes an audio-device output sound power calculating unit 451, a noise power estimating unit 452, a noise power table bank 453, a table selecting unit 454, and a S/N ratio level calculating unit 455.

The audio-device output sound power calculating unit 451 calculates a power P_{A} of the simulation audio signal yˆ(j) output from the adaptive filter 41. The table selecting unit 454 obtains, from the navigation device 12 via the status information input interface 46, currently traveled road information which indicates the type of a road on which a vehicle is traveling, traffic congestion information which indicates the presence of a traffic congestion at a point where the vehicle is traveling and the extent of the traffic congestion, and weather information which indicates the weather of an area in which the vehicle is traveling.

The navigation device 12 includes a present position calculating unit. The navigation device 12 determines, on the basis of geographical information, the type of a currently traveled road indicated by a present position calculated by the present position calculating unit (Normal road, Bridge, or Tunnel) and outputs the determination result as the currently traveled road information to the status information input interface 46. The navigation device 12 obtains a traffic status indicating that a currently traveled point indicated by the present position calculated by the present position calculating unit is no traffic congestion, light congestion, or heavy congestion by using the VICS receiver 13 and outputs the obtained data as the traffic congestion information to the status information input interface 46. The navigation device 12 connects to a server device that provides weather information via the communication device 14, obtains a weather status indicating that an area containing the present position calculated by the present position calculating unit is Fair/Cloudy, Snowy, or Rainy from the server device and outputs the obtained data as the weather information to the status information input interface 46.

The noise power table bank 453 stores noise power tables individually corresponding to a total of 27 combinations of three road type values (Normal road, Bridge, and Tunnel) indicated by the currently traveled road information, three congestion status values (No congestion, Light congestion, and Heavy congestion) indicated by the traffic status information, and three weather status values (Fair/Cloudy, Snowy, and Rainy) indicated by the weather information. As illustrated in parts B1 and B2 in FIG. 2, each noise power table shows the relationship between the vehicle speed and the power of noise occurring inside the vehicle in a corresponding condition among the combinations. For example, a noise power table corresponding to a combination of normal road, no congestion, and fair/cloudy, as illustrated in part B1 of FIG. 2, shows the relationship between the vehicle speed and the power of noise occurring inside the vehicle when the vehicle is traveling on a normal road with no traffic congestion in a fair or cloudy condition. A noise power table corresponding to a combination of bridge, no congestion, and fair/cloudy, as illustrated in part B2 of FIG. 2, shows the relationship between the vehicle speed and the power of noise occurring inside the vehicle when the vehicle is traveling on a road on a bridge with no traffic congestion in a fair or cloudy condition. The noise power occurring inside a vehicle has a tendency to increase in the order of Normal road, Bridge, and Tunnel in the road type of a road where the vehicle is currently traveling. The noise power occurring inside a vehicle has a tendency to increase in the order of No congestion, Light congestion, and Heavy congestion in the traffic congestion status. The noise power occurring inside a vehicle has a tendency to increase in the order of Fair/Cloudy, Snowy, and Rainy in the weather status.

The relationship between the vehicle speed and the noise power occurring inside the vehicle illustrated in each noise power table is determined in advance by experiment and/or calculation.

The table selecting unit 454 selects, from the noise power tables stored in the noise power table bank 453, a noise power table that corresponds to a combination of the road type indicated by the currently traveled road information, the traffic congestion status indicated by traffic congestion information, and the weather status indicated by the weather information, the information items being obtained from the navigation device 12.

The noise power estimating unit 452 obtains the vehicle speed detected by the ECU 11 from the ECU 11 via the status information input interface 46. On the basis of the relationship between the vehicle speed and the noise power indicated by the noise power table selected by the table selecting unit 454, a noise power P_{N} corresponding to the vehicle speed obtained from the ECU 11 is estimated.

The S/N ratio level calculating unit 455 calculates, as the S/N ratio, the ratio between the power P_{A} of the simulation audio signal yˆ(j) calculated by the audio-device output sound power calculating unit 451 and the noise power P_{N} estimated by the noise power estimating unit 452 by using expression 1:
S/N ratio=10′ Log₁₀(P_{A}/P_{N}) (1)

The S/N ratio level calculating unit 455 determines the level of the calculated S/N ratio (Good, Normal, or Bad) in accordance with preset S/N ratio ranges defining Good, Normal, and Bad levels, and outputs the determined level (Good, Normal, or Bad) as the S/N ratio level to the adaptive characteristic controller 43. The S/N ratio ranges defining Good, Normal, and Bad levels are set such that a range corresponding to a large S/N ratio is defined as Good, a range corresponding to an intermediate S/N ratio is defined as Normal, and a range corresponding to a small S/N ratio is defined as Bad.

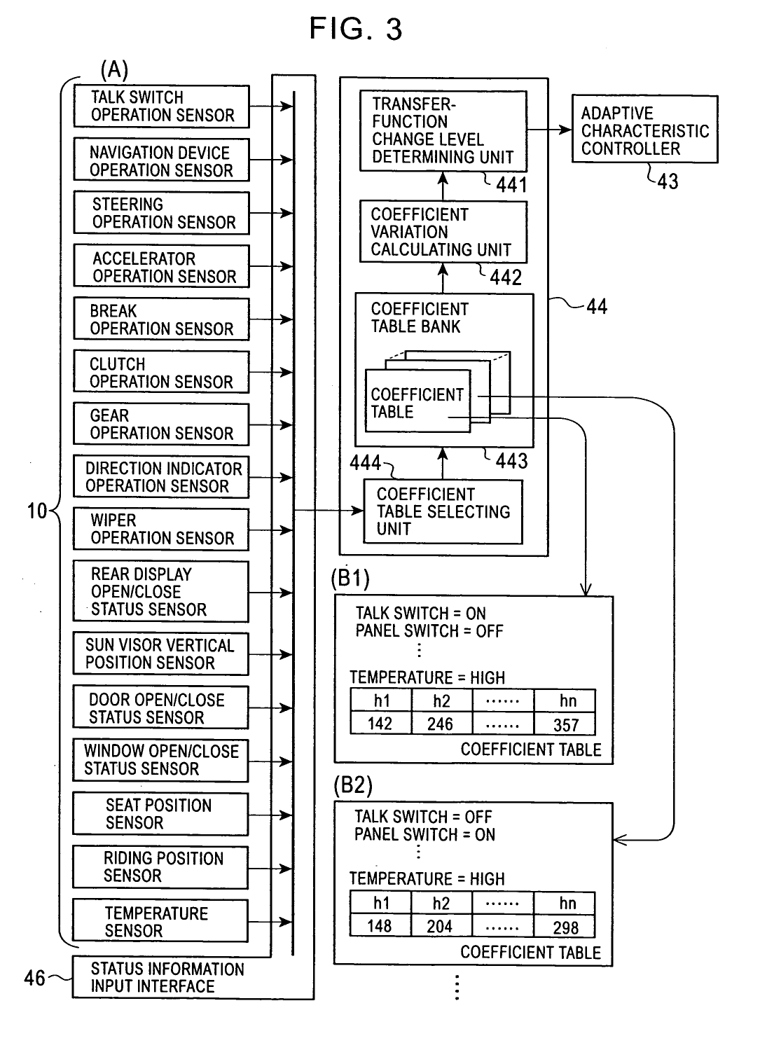

FIG. 3 illustrates one embodiment of a structure of the transfer-function variation estimating unit 44 in part A. As illustrated, the transfer-function variation estimating unit 44 includes a transfer-function change level determining unit 441, a coefficient variation calculating unit 442, a coefficient table bank 443, and a coefficient table selecting unit 444.

In the structure described above, the coefficient table selecting unit 444 obtains various statuses of a vehicle detected by the sensors 10 via the status information input interface 46.

As illustrated, examples of the sensors 10 may include a talk switch operation sensor for detecting the operation state of the talk switch 8 and a navigation-device operation sensor for the operation state of the navigation device 12. Other examples of the sensors 10 may include a steering operation sensor, an accelerator operation sensor, a break operation sensor, a clutch operation sensor, and a gear operation sensor, which are used for detecting the operation states of vehicle driving equipment, such as steering, breaking, clutching, and gear shifting, respectively. Still other examples of the sensors 10 may include a direction indicator operation sensor and a wiper operation sensor, which are used for detecting the operation states of vehicle auxiliary equipment, such as a direction indicator and a wiper, respectively.

Other examples of the sensors 10 may include a rear display open/close status sensor for detecting the open/close status of a rear display, a sun visor vertical position sensor for detecting the vertical position of a sun visor, a door open/close status sensor for detecting the open/close status of a door, a window open/close status sensor for detecting the open/close status n of a window, a seat position sensor for detecting the position of a seat, a riding position sensor for detecting a position in which a person rides, and a temperature sensor for detecting the temperature inside the vehicle.

The coefficient table bank 443 stores coefficient tables corresponding to combinations of outputs of the sensors 10. As illustrated in parts B1 and B2 in FIG. 2, each coefficient table registers tap coefficients (h1, h2, . . . , hn) of the FIR filter 411. The tap coefficients of the FIR filter 411 registered in each coefficient table are used to cause the FIR filter 411 to simulate a transfer function of the audio-device output audio signal transfer system, the transfer function being estimated to be when the vehicle is in a state indicated by a combination of statuses output from the sensors 10 corresponding to the coefficient table. The tap coefficients registered in each coefficient table are determined in advance by experiment and/or calculation.

The coefficient table selecting unit 444 selects, from the coefficient tables stored in the coefficient table bank 443, a coefficient table corresponding to a combination of statuses output from the sensors 10 obtained via the status information input interface 46 at predetermined intervals.

Then, the coefficient variation calculating unit 442 determines the amount of variation in coefficient (coefficient variation) by using a difference between a tap coefficient indicated by the selected coefficient table and a tap coefficient indicated by a previously selected coefficient table. The coefficient variation, DTF, is determined by using expression 2:

$$Δ TF = \sqrt{{\sum }_{i = 1}^{N} {( Δ {h}_{i} )}^{2}} \qquad ( 2 )$$

where Dhi is the absolute value of a difference between an i-th tap coefficient indicated by the currently selected coefficient table and an i-th tap coefficient indicated by the previously selected coefficient table.

The transfer-function change level determining unit 441 determines the level of the coefficient variation DTF (Large, Medium, or Small) on the basis of predetermined ranges of the coefficient variation DTF defining Large, Medium, and Small levels and outputs the determined level (Large, Medium, or Small) of the coefficient variation DTF as the transfer-function change level to the adaptive characteristic controller 43.

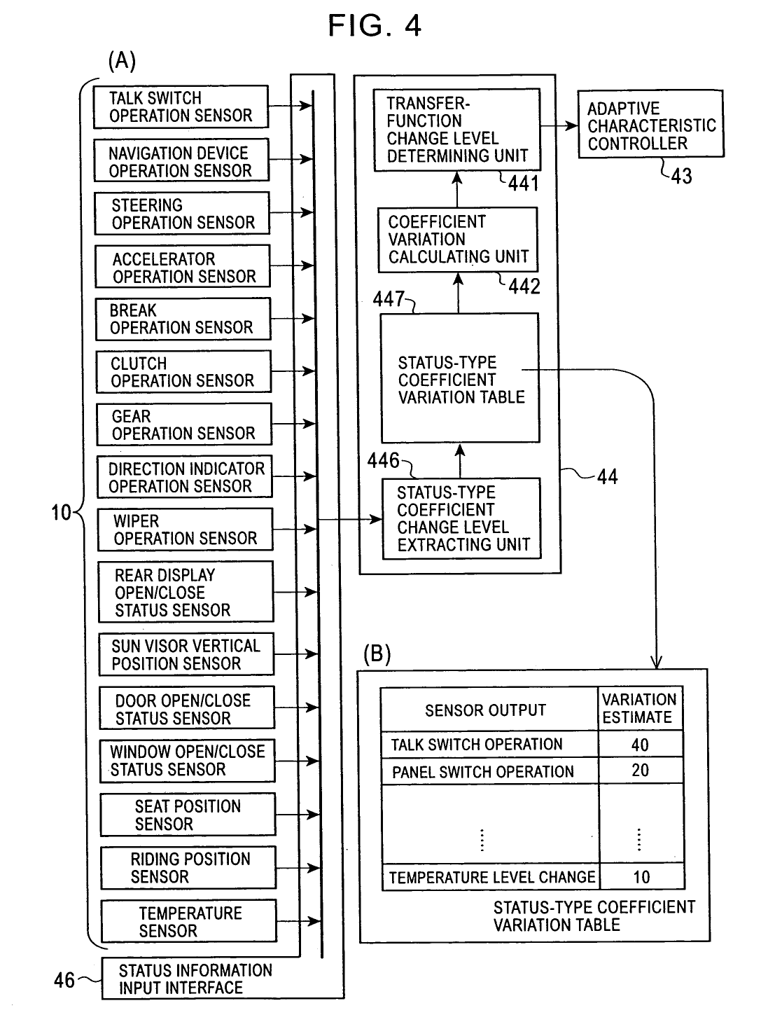

The transfer-function variation estimating unit 44 may have a structure illustrated in part A of FIG. 4. As illustrated in FIG. 4, the coefficient table selecting unit 444 and the coefficient table bank 443 in the transfer-function variation estimating unit 44 illustrated in part A of FIG. 3 can be replaced with a status-type coefficient change level extracting unit 446 and a status-type coefficient variation table 447.

As illustrated in part B of FIG. 4, the status-type coefficient variation table 447 registers an estimate of a change in the transfer function of the audio-device output audio signal transfer system (variation estimate) occurring when the output of each of the sensors 10 is changed, in units of outputs or output values of the sensors 10 obtained by the transfer-function variation estimating unit 44. The variation estimate registered in the status-type coefficient variation table 447 is determined in advance by experiment and/or calculation in response to a change in a vehicle status indicated by the output of a corresponding sensor 10.

The status-type coefficient change level extracting unit 446 determines the change in the output of each of the sensors 10 obtained via the status information input interface 46 at predetermined intervals. For a sensor 10 whose change has been detected, the status-type coefficient change level extracting unit 446 transmits, to the coefficient variation calculating unit 442, a variation estimate registered in the status-type coefficient variation table 447, the variation estimate corresponding to the output or output value of a sensor 10 whose change has been detected.

Then, the coefficient variation calculating unit 442 calculates, as the coefficient variation DTF, a maximum value of the transmitted variation estimate. The transfer-function change level determining unit 441 determines the level of the coefficient variation DTF (Large, Medium, or Small) on the basis of predetermined ranges of the coefficient variation DTF corresponding to Large, Medium, and Small levels and outputs the determined level (Large, Medium, or Small) of the coefficient variation DTF as the transfer-function change level to the adaptive characteristic controller 43.

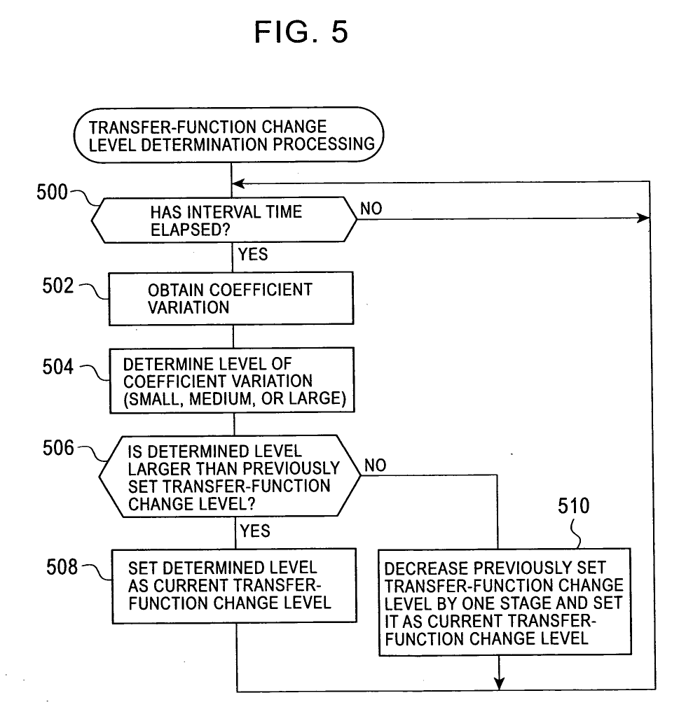

The transfer-function change level determining unit 441 of the transfer-function variation estimating unit 44 illustrated in part A of FIGS. 3 and 4 may calculate the transfer-function change level by executing transfer-function change level determination processing shown in FIG. 5.

At predetermined time intervals (step 500), the coefficient variation DTF is obtained from the coefficient variation calculating unit 442 (step 502), and the level of the obtained coefficient variation DTF (Large, Medium, or Small) is determined (step 504).

In step 506, it is determined whether the level determined in step 504 is larger than a previously calculated transfer-function change level. If the determined level in step 504 is larger than the previous one (YES in step 506), the determined level in step 504 is calculated as the current transfer-function change level and is output to the adaptive characteristic controller 43 (step 508). Medium level is larger than Small level, and Large level is larger than Medium level. The processing returns to step 500 and waits until the predetermined interval time elapses.

If the level determined in step 504 is not larger than the previously calculated transfer-function change level (NO in step 506), a transfer-function change level obtained by decreasing the previously calculated transfer-function change level by one stage is calculated as the current transfer-function change level and is output to the adaptive characteristic controller 43 (step 510). If the previously calculated transfer-function change level is Large, the transfer-function change level obtained by decreasing the previously calculated transfer-function change level by one stage is Medium. If the previously calculated transfer-function change level is Medium, the transfer-function change level obtained by decreasing the previously calculated transfer-function change level by one stage is Small. If the previously calculated transfer-function change level is Small, the transfer-function change level obtained by decreasing the previously calculated transfer-function change level by one stage remains at Small. The processing returns to step 500 and waits until the predetermined interval time elapses.

The transfer-function change level determination processing described above enables control in which, when a coefficient variation DTF whose classified level is larger than the previously calculated transfer-function change level occurs, the transfer-function change level is successively reduced from the transfer-function change level in which the occurring coefficient variation DTF is classified. Such control is effective for appropriately estimating the transfer-function change level for the case where, for example, when an event, such as an operation detected by the sensors 10, occurs, the transfer function then varies with time in response to the operation associated with the event. The transfer-function change level determination processing as described above may perform control in which, only when an output of the sensor 10 causing the coefficient variation DTF to change is detection of an event that causes the transfer function to change with time after the event occurs, the transfer-function change level is successively reduced with time from the level in which the coefficient variation DTF is classified.

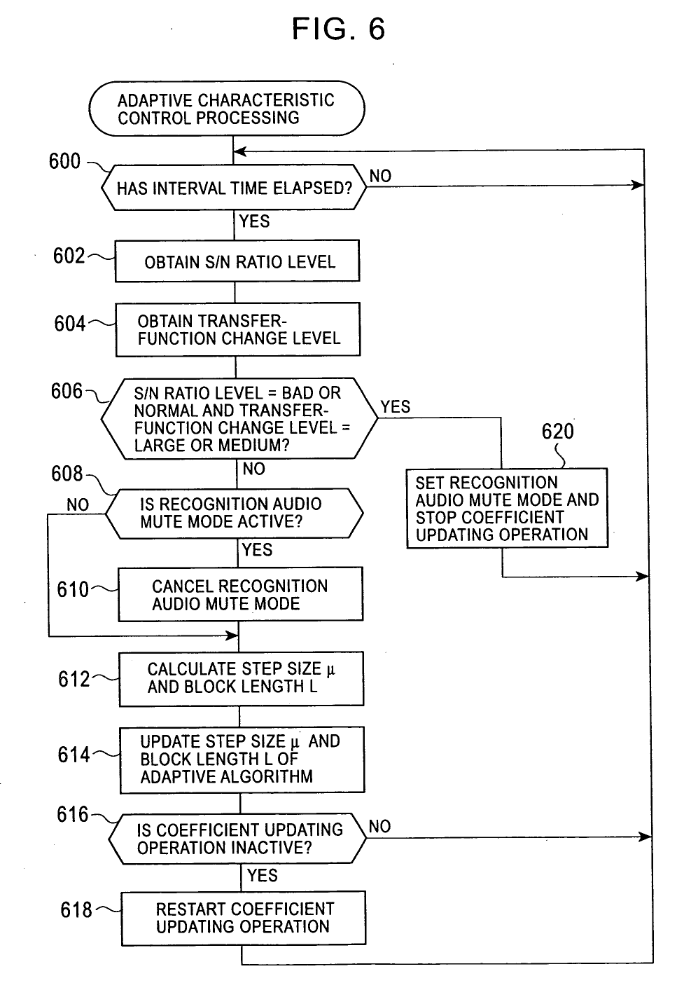

The adaptive characteristic controller 43 performs adaptive-characteristic control processing illustrated in FIG. 6. In this case, the coefficient updating unit 412 in the adaptive filter 41 updates the coefficient of the FIR filter 411 by using a block-processing NLMS adaptive algorithm represented by expression 3:

$$w ( n + 1 ) = w ( n ) + μ \cdot \frac{1}{{\sum }_{j = nL + 1}^{( n + 1 ) L} ⨯ {( j )}^{T} ⨯ ( j )} \cdot {\sum }_{j = nL + 1}^{( n + 1 ) L} e ( j ) ⨯ ( j ) \qquad ( 3 )$$

where m is the step size parameter and L is the block length, which are variables controlled by the adaptive characteristic controller 43.

In the adaptive characteristic control processing, at predetermined time intervals (step 600), the S/N ratio level calculated by the S/N ratio estimating unit 45 is obtained (step 602), and the transfer-function change level calculated by the transfer-function variation estimating unit 44 is obtained (step 604).

In step 606, it is determined whether the S/N ratio level is Bad or Normal and whether the transfer-function change level is Large or Medium (step 606). If the S/N ratio is Bad or Normal and/or the transfer-function change leve is Large or Medium (YES in step 606), the coefficient updating operation of the coefficient updating unit 412 in the adaptive filter 41 is stopped, and a recognition audio mute mode is set to active in the audio mute controller 9 (step 620). When the recognition audio mute mode is set to active, as described above, the audio device 1 does not output the audio-device output audio signal x(j) during voice recognition.

If the S/N ratio level is neither Bad nor Normal and/or the transfer-function change level is neither Large nor Medium (NO in step 606), it is determined whether the recognition audio mute mode is active in the audio mute controller 9 (step 608). If the recognition audio mute mode is not active, the processing proceeds to step 612. If the recognition audio mute mode is active, the mode is canceled (step 610), and the processing then proceeds to step 612.

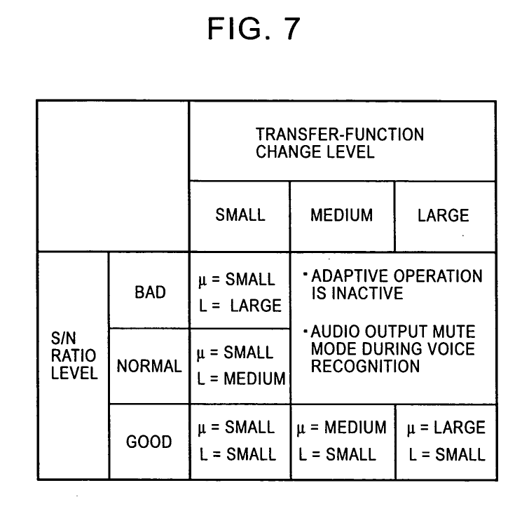

In step 612, the step size parameter m and the block length L are determined on the basis of a combination of the S/N ratio level and the transfer-function change level and a table illustrated in FIG. 7. Then, the step size parameter m and the block length L of the adaptive algorithm performed by the coefficient updating unit 412 in the adaptive filter 41 are updated with the determined step size parameter m and block length L (step 614). If the coefficient updating operation in the coefficient updating unit 412 is inactive (YES in step 616), the coefficient updating operation in the coefficient updating unit 412 is restarted (step 618). The processing then returns to step 600 and waits until the next interval time elapses.

As illustrated in FIG. 7, in the adaptive characteristic control processing, as the S/N ratio level degrades, the block length L is increased. As the transfer-function change level increases, the step size parameter m is increased.

It is expected that, when the transfer function widely varies, increasing the step size parameter m enables the adaptation (learning) to converge faster. It is expected that, when the S/N ratio level is small, increasing the block length L improves the accuracy of the adaptation (learning).

As a result, according to the embodiments, a control parameter of an adaptation operation of estimating the S/N ratio level and the transfer-function change level from various vehicle statuses collected from the navigation device 12, the ECU 11, and the sensors 10 and allowing the adaptation operation to match the estimated S/N ratio level and the estimated transfer-function change level can be set in the adaptive filter 41. Therefore, even when the noise level is large or the transfer function widely varies, the adaptive filter 41 can perform the adaptation (learning) operation with increased accuracy.

The embodiments describe an application to an in-vehicle audio processing apparatus that performs voice recognition. A technique that controls an adaptive operation characteristic (e.g., block length L and step size parameter L) in response to various vehicle statuses according to the present disclosure can also be applied to control of an adaptive operation characteristic of the adaptive filter 41 applied to an echo canceller of a voice communication device in any in-vehicle audio processing apparatus or another unit. If it is applied to the echo canceller of the voice communication device, the adaptive filter 41 is configured to estimate a received sound output from the speaker 2.

It is therefore intended that the foregoing detailed description be regarded as illustrative rather than limiting, and that it be understood that it is the following claims, including all equivalents, that are intended to define the spirit and scope of the disclosure.

1. An in-vehicle audio processing apparatus mounted in a vehicle, the apparatus comprising:
an audio output device;
a speaker for outputting an output audio signal as an output sound that is output from the audio output device;
a microphone for outputting an input audio signal, the input audio signal based on sound that is picked up at the microphone;
an adaptive filter operative to perform an adaptation operation to cause a first transfer function to approximate a second transfer function of a system whose input is the output audio signal that is output from the audio output device and whose output is the input audio signal from the microphone, to apply the first transfer function to the output audio signal, and to output a simulation audio signal which simulates a component corresponding to the output sound contained in the input audio signal;
a vehicle-status collecting unit for collecting a vehicle status regarding surroundings of the in-vehicle audio processing apparatus; and
an adaptive characteristic controller for controlling a control parameter of the adaptation operation of the adaptive filter based on the vehicle status collected by the vehicle-status collecting unit.

2. The in-vehicle audio processing apparatus according to claim 1, wherein the vehicle-status collecting unit collects a vehicle status that influences a change in the second transfer function.

3. The in-vehicle audio processing apparatus according to claim 2, wherein the adaptive filter includes an FIR filter and a coefficient updating unit operative to update a tap coefficient of the FIR filter, and
wherein the adaptive characteristic controller changes a step size parameter defining a gain of correction of the tap coefficient, the correction being performed in updating the tap coefficient of the FIR filter by the coefficient updating unit, in response to a change in the vehicle status collected by the vehicle-status collecting unit.

4. The in-vehicle audio processing apparatus according to claim 3, wherein the vehicle-status collecting unit collects, as the vehicle status that influences the change in the second transfer function, at least one of an operation status of driving equipment of the vehicle, an operation status of subsidiary equipment of the vehicle, an operation status of accessory equipment of the vehicle, an open/close status of a window of the vehicle, an open/close status of a door of the vehicle, a status of a position at which a person rides in the vehicle, a status of a position at which a seat of the vehicle is set, and a status of a temperature inside the vehicle.

5. The in-vehicle audio processing apparatus according to claim 3, further comprising a voice recognition device for applying voice recognition processing to an audio signal obtained by subtracting the simulation audio signal from the input audio signal.

6. The in-vehicle audio processing apparatus according to claim 2, wherein the vehicle-status collecting unit collects, as the vehicle status that influences the variation in the second transfer function, at least one of an operation status of driving equipment of the vehicle, an operation status of subsidiary equipment of the vehicle, an operation status of accessory equipment of the vehicle, an open/close status of a window of the vehicle, an open/close status of a door of the vehicle, a status of a position at which a person rides in the vehicle, a status of a position at which a seat of the vehicle is set, and a status of a temperature inside the vehicle.

7. The in-vehicle audio processing apparatus according to claim 1, wherein the vehicle-status collecting unit collects a vehicle status that influences a magnitude of noise inside the vehicle.

8. The in-vehicle audio processing apparatus according to claim 7, wherein the adaptive filter includes an FIR filter and a coefficient updating unit for updating a tap coefficient of the FIR filter on the basis of an adaptive algorithm including block processing in which an amount of correction of the tap coefficient is calculated using data for a length of time set as a block length to update the tap coefficient, and
wherein the adaptive characteristic controller changes the block length of the block processing performed by the coefficient updating unit, in response to a change in the vehicle status collected by the vehicle-status collecting unit.

9. The in-vehicle audio processing apparatus according to claim 8, wherein the vehicle-status collecting unit collects at least a status of a vehicle speed as the vehicle status that influences the magnitude of noise inside the vehicle, and
wherein the adaptive characteristic controller sets the block length of the block processing performed by the coefficient updating unit at a value determined based on on the vehicle speed collected by the vehicle-status collecting unit.

10. The in-vehicle audio processing apparatus according to claim 8, wherein the vehicle-status collecting unit collects, as the vehicle status that influences the magnitude of noise inside the vehicle, at least one of a status of a vehicle speed, a status of a type of a road where the vehicle is traveling, a status of weather of an area in which the vehicle is traveling, and a status of congestion at a point where the vehicle is traveling, and
wherein the adaptive characteristic controller sets the block length of the block processing performed by the coefficient updating unit at a value determined based on on a combination of one or more statuses collected by the vehicle-status collecting unit.

11. The in-vehicle audio processing apparatus according to claim 7, wherein the vehicle-status collecting unit collects, as the vehicle status that influences the magnitude of noise inside the vehicle, at least one of a status of a vehicle speed, a status of a type of a road where the vehicle is traveling, a status of weather of an area in which the vehicle is traveling, and a status of congestion at a point where the vehicle is traveling.

12. The in-vehicle audio processing apparatus according to claim 11, further comprising a voice recognition device for applying voice recognition processing to an audio signal obtained by subtracting the simulation audio signal from the input audio signal.

13. The in-vehicle audio processing apparatus according to claim 1, wherein the vehicle-status collecting unit collects a vehicle status that influences a change in the second transfer function of the system whose input is the output audio signal and whose output is the input audio signal and a vehicle status that influences a magnitude of noise inside the vehicle.

14. The in-vehicle audio processing apparatus according to claim 13, wherein the adaptive filter includes an FIR filter and a coefficient updating unit for updating a tap coefficient of the FIR filter on the basis of an adaptive algorithm including block processing in which an amount of correction of the tap coefficient is calculated using data for a length of time set as a block length to update the tap coefficient, and
wherein the adaptive characteristic controller changes a step size parameter defining a gain of correction of the tap coefficient, the correction being performed in updating the tap coefficient of the FIR filter by the coefficient updating unit, in response to a change in the vehicle status that influences the change in the second transfer function of the system whose input is the output audio signal and whose output is the input audio signal and changes the block length of the block processing performed by the coefficient updating unit, in response to a change in the vehicle status that influences the magnitude of noise inside the vehicle collected by the vehicle-status collecting unit.

15. The in-vehicle audio processing apparatus according to claim 14, wherein the coefficient updating unit in the adaptive filter updates the tap coefficient of the FIR filter using the following expression:
$$w ( n + 1 ) = w ( n ) + μ \cdot \frac{1}{{\sum }_{j = nL + 1}^{( n + 1 ) L} ⨯ {( j )}^{T} ⨯ ( j )} \cdot {\sum }_{j = nL + 1}^{( n + 1 ) L} e ( j ) ⨯ ( j )$$
where w(n) is the tap coefficient of the FIR filter, x(j) is the output audio signal output from the audio output device, e(j) is a difference between the input audio signal and the simulation audio signal, m is the step size parameter, and L is the block length, and
wherein the adaptive characteristic controller changes the step size parameter m in response to the change in the vehicle status that influences the change in the second transfer function of the system whose input is the output audio signal and whose output is the input audio signal collected by the vehicle-status collecting unit and changes the block length L in response to the change in the vehicle status that influences the magnitude of noise inside the vehicle collected by the vehicle-status collecting unit.

16. The in-vehicle audio processing apparatus according to claim 14, further comprising a voice recognition device for applying voice recognition processing to an audio signal obtained by subtracting the simulation audio signal from the input audio signal.

17. The in-vehicle audio processing apparatus according to claim 1, further comprising a voice recognition device for applying voice recognition processing to an audio signal obtained by subtracting the simulation audio signal from the input audio signal.

18. A method for controlling an adaptation operation of an adaptive filter in an in-vehicle audio processing apparatus mounted in a vehicle, the in-vehicle audio processing apparatus including an audio output device, a speaker for outputting an output audio signal output from the audio output device as an output sound, a microphone for outputting a picked up sound as an input audio signal, and an adaptive filter for performing an adaptation operation of causing a first transfer function of the adaptive filter to approximate a second transfer function of a system whose input is the output audio signal and whose output is the input audio signal and for applying the first transfer function of the adaptive filter to the output audio signal and outputting a simulation audio signal which simulates a component corresponding to the output sound contained in the input audio signal, the method comprising:
a first step of collecting a vehicle status regarding surroundings of the in-vehicle audio processing apparatus; and
a second step of controlling a control parameter of the adaptation operation of the adaptive filter in response to the collected vehicle status.

19. The method according to claim 18, wherein the adaptive filter includes an FIR filter and a coefficient updating unit for updating a tap coefficient of the FIR filter,
wherein the first step collects a vehicle status that influences a change in the second transfer function of the system whose input is the output audio signal and whose output is the input audio signal, and
wherein the second step changes a step size parameter defining a gain of correction of the tap coefficient, the correction being performed in updating the tap coefficient of the FIR filter by the coefficient updating unit, in response to a change in the collected vehicle status.

20. The method according to claim 18, wherein the adaptive filter includes an FIR filter and a coefficient updating unit for updating a tap coefficient of the FIR filter on the basis of an adaptive algorithm including block processing in which an amount of correction of the tap coefficient is calculated using data for a length of time set as a block length to update the tap coefficient,
wherein the first step collects a vehicle status that influences a magnitude of noise inside the vehicle, and
wherein the second step changes the block length of the block processing performed by the coefficient updating unit, in response to a change in the collected vehicle status.
